(19) United States
(12) Patent Application Publication
(10) Pub. No.: US 2026/0188228 A1
(43) Pub. Date: Jul. 2, 2026

(54) PIXEL DRIVE CIRCUIT AND ITS CONTROL METHOD, AND DISPLAY DEVICE

(71) Applicant: HKC CORPORATION LIMITED, Shenzhen (CN)

(72) Inventors: Mengling Wang, Shenzhen (CN); Chenguang Tong, Shenzhen (CN); Xiaojing Chang, Shenzhen (CN); Longxin Xiao, Shenzhen (CN); Yuanchen Wang, Shenzhen (CN); Jinjing Fang, Shenzhen (CN); Lan Li, Shenzhen (CN); Pei Xu, Shenzhen (CN)

(21) Appl. No.: 19/412,841

(22) Filed: Dec. 8, 2025

(30) Foreign Application Priority Data
Dec. 28, 2024 (CN) 202411955409.9

(51) Int. Cl. G09G 3/3233

(52) U.S. Cl. CPC G09G 3/3233; G09G 2300/0819; G09G 2300/0852; G09G 2300/0861; G09G 2310/08; G09G 2320/0233; G09G 2320/0653; G09G 2360/144; G09G 2360/148

(57) ABSTRACT

A pixel drive circuit, which includes an adjustment sub-circuit, a drive sub-circuit, a compensation sub-circuit, a drive control sub-circuit, a first reset sub-circuit, a second reset sub-circuit, a first light-emitting control sub-circuit, a second light-emitting control sub-circuit and a storage sub-circuit. In the present application, the pixel drive circuit compensates for the leakage current at a first node during a data writing phase, enabling the drive transistor to continuously generate a drive current during a light-emitting phase. As a result, the display device employing the pixel drive circuit exhibit superior brightness performance, excellent light-emitting effects, and enhanced overall performance.

### CROSS-REFERENCE TO RELATED APPLICATION

Pursuant to 35 U.S.C. § 119 and the Paris Convention, this application claims the benefit of Chinese Patent Application No. 202411955409.9 filed on Dec. 28, 2024, the content of which is incorporated herein by reference.

### FIELD OF TECHNOLOGY

The following relates the field of display technology, more particularly to a pixel drive circuit, a control method for the pixel drive circuit, and a display device.

### BACKGROUND

Organic light-emitting Diode (OLED) display devices possess advantages of self-illumination, high contrast ratio, wide color gamut, and broad operating temperature range, gradually receiving increasingly extensive research and application. The luminance of the OLED display device is related to the amount of current flowing, especially to a drive current generated by a drive transistor in a pixel drive circuit.

Current drive transistors often exhibit process variations during fabrication, making it difficult to produce completely identical drive transistors. Consequently, there are variations in threshold voltage of the drive transistors applied in pixel drive circuits. Moreover, factors such as prolonged operation time and changes in the usage environment can cause the threshold voltage of the drive transistor to drift. These issues affect the drive current of the drive transistor, leading to brightness-related problems in OLED display devices, such as increased luminance and brightness flickering, which severely compromise the performance of the display devices.

Therefore, it is urgent to provide a novel pixel drive circuit to solve the above problems.

### SUMMARY

In view of this, a pixel drive circuit, a control method for the pixel drive circuit, and a display device are provided in embodiments of the present application. The pixel drive circuit compensates for a leakage current at a first node during a data writing phase, enabling the drive transistor to continuously generate a drive current during a light-emitting phase. This results in superior brightness performance, excellent light-emitting effects, and enhanced overall performance for the display device utilizing this pixel drive circuit.

In accordance with a first aspect of the embodiments of the present application, a pixel drive circuit is provided, which includes: an adjustment sub-circuit, a drive sub-circuit, a compensation sub-circuit, a drive control sub-circuit, a first reset sub-circuit, a second reset sub-circuit, a first light-emitting control sub-circuit, a second light-emitting control sub-circuit, and a storage sub-circuit.

The adjustment sub-circuit is electrically connected to a voltage control signal line, a second scan signal line, a first node, and a power supply voltage line, and is configured to compensate for the leakage current at the first node under the joint control of a voltage control signal from the voltage control signal line and a scan signal from the second scan signal line during a data writing phase.

The drive sub-circuit is electrically connected to the first node, a second node, and a third node, and is configured to establish a conductive path between the second node and the third node under a control of a voltage of the first node, so that a current for driving the light-emitting element to emit light is generated in the conductive path, and the current is continuously generated during a light-emitting phase.

The compensation sub-circuit is electrically connected to the second scan signal line, the first node, and the third node, and is configured to establish a conductive path between the first node and the third node under a control of a scan signal from the second scan signal line.

The drive control sub-circuit is electrically connected to the second scan signal line, a data signal line and the second node, and is configured to write a data signal from the data signal line into the second node under the control of the scan signal from the second scan signal line.

The first reset sub-circuit is electrically connected to a first scan signal line, an initial signal line and the first node, and is configured to reset the first node by an initial signal from the initial signal line under control of a scan signal from the first scan signal line. The second reset sub-circuit is electrically connected to the second scan signal line, a reset signal line and an anode of the light-emitting element, and is configured to reset the anode of the light-emitting element by a reset signal from the reset signal line under control of a scan signal from the second scan signal line.

The first light-emitting control sub-circuit is electrically connected to a light-emitting control signal line, the power supply voltage line and the second node. The second light-emitting control sub-circuit is electrically connected to the light-emitting control signal line, the third node and the anode of the light-emitting element. The first light-emitting control sub-circuit and the second light-emitting control sub-circuit are respectively configured to transmit the current for driving the light-emitting element to emit light to the anode of the light-emitting element under a control of a light-emitting control signal from the light-emitting control signal line.

The storage sub-circuit is electrically connected to the power supply voltage line and the first node, and is configured to maintain the voltage at the first node.

In one embodiment, the adjustment sub-circuit includes a photosensitive capacitor and a dual-gate transistor.

A first electrode of the photosensitive capacitor is electrically connected to the voltage control signal line, and a second electrode of the photosensitive capacitor is electrically connected to a first control electrode of the dual-gate transistor.

A second control electrode of the dual-gate transistor is electrically connected to the second scan signal line, a first electrode of the dual-gate transistor is electrically connected to the power supply voltage line, and a second electrode of the dual-gate transistor is electrically connected to the first node.

In an embodiment, the drive sub-circuit includes a drive transistor.

A control electrode of the drive transistor is electrically connected to the first node, a first electrode of the drive transistor is electrically connected to the second node, and a second electrode of the drive transistor is electrically connected to the third node.

In an embodiment, the compensation sub-circuit includes a fifth transistor.

A control electrode of the fifth transistor is electrically connected to the second scan signal line, a first electrode of the fifth transistor is electrically connected to the third node, and a second electrode of the fifth transistor is electrically connected to the first node.

In an embodiment, the drive control sub-circuit includes a sixth transistor.

A control electrode of the sixth transistor is electrically connected to the second scan signal line, a first electrode of the sixth transistor is electrically connected to the data signal line, and a second electrode of the sixth transistor is electrically connected to the second node.

In an embodiment, the first reset sub-circuit includes a first transistor, a control electrode of the first transistor is electrically connected to the first scan signal line, a first electrode of the first transistor is electrically connected to the initial signal line, and a second electrode of the first transistor is electrically connected to the first node.

The second reset sub-circuit includes a second transistor, a control electrode of the second transistor is electrically connected to the second scan signal line, a first electrode of the second transistor is electrically connected to the reset signal line, and a second electrode of the second transistor is electrically connected to the anode of the light-emitting element.

In an embodiment, the first light-emitting control sub-circuit includes a third transistor, a control electrode of the third transistor is electrically connected to the light-emitting control signal line, a first electrode of the third transistor is electrically connected to the power supply voltage line, and a second electrode of the third transistor is electrically connected to the second node.

The second light-emitting control sub-circuit includes a fourth transistor, a control electrode of the fourth transistor is electrically connected to the light-emitting control signal line, a first electrode of the fourth transistor is electrically connected to the third node, and a second electrode of the fourth transistor is electrically connected to the anode of the light-emitting element.

In an embodiment, the storage sub-circuit includes a storage capacitor.

A first electrode of the storage capacitor is electrically connected to the power supply voltage line, and a second electrode of the storage capacitor is electrically connected to the first node.

In accordance with a second aspect of the embodiments of the present application, a display device is provided, which includes a plurality of pixel units arranged in an array and the above-mentioned pixel drive circuit. The pixel drive circuit is electrically connected to the plurality of pixel units and is configured to control the plurality of pixel units.

In accordance with a third aspect of the embodiment of the present application, a control method for controlling the pixel drive circuit. The control method includes a step of:
implementing, within one frame display cycle, a display of a frame image through a reset phase, the data writing phase and the light-emitting phase.

The pixel drive circuit provided in the first aspect of the embodiment of the present application can compensate for the leakage current at the first node during the data writing phase by configuring the adjustment sub-circuit as the compensation sub-circuit, so that a potential at the first node changes as little as possible or does not change, so that the potential at the control electrode of the drive transistor is relatively stable, the drive transistor continuously generates a drive current during the light-emitting phase, and the brightness of the light-emitting element changes as little as possible or does not change. Consequently, the problems of increased brightness and brightness flickering of the display device employing the pixel drive circuit is effectively reduced, thereby the display device can achieve superior brightness performance, excellent light-emitting effects, and enhanced overall performance.

The control method for the pixel drive circuit provided in the third aspect of the embodiment of the present application, when the ambient light varies, the change in the quantity of charges within the photosensitive capacitor during the data writing phase induces a change in the current of the dual-gate transistor. During the data writing phase, opposing electric fields are formed between the first and second electrodes of the dual-gate transistor, exerting contrary effects on holes and electrons. Under the influence of dual electric fields, the electron flow rate in dual-gate transistors is faster, attracting a greater number of electrons and resulting in a higher on-state current. This compensates for the leakage current at the first node caused by factors such as illumination or prolonged charging, thereby enabling the drive transistor to continuously generate the drive current during the light-emitting phase and minimizing changes in the brightness of the light-emitting element. Additionally, this approach allows the pixel drive circuit to drive the light-emitting element effectively, with a simple and easily achievable timing sequence.

It can be understood that the beneficial effects of the second aspect can be referred to the related description in the first and third aspects, which will not be repeated here.

### BRIEF DESCRIPTION OF THE DRAWINGS

To provide a clearer illustration of technical schemes in embodiments of the present application, the drawings that required for describing the embodiments will be briefly introduced below. Obviously, the drawings in the following description are merely some embodiments of the present application. For persons of ordinary skill in the art, other drawings may also be obtained from these drawings without exerting creative efforts.

FIG. 1 is a schematic diagram of a pixel drive circuit according to an embodiment of the present application;

FIG. 2 is a schematic diagram of a dual-gate transistor according to an embodiment of the present application;

FIG. 3 is a schematic diagram of an adjustment sub-circuit composed of a dual-gate transistor and a storage capacitor according to an embodiment of the present application;

FIG. 4 is a schematic diagram of a current at a first node before and after compensation according to an embodiment of the present application;

FIG. 5 is a schematic diagram of a control method for a pixel drive circuit according to an embodiment of the present application;

FIG. 6 is a drive timing diagram of a pixel drive circuit according to an embodiment of the present application; and

FIGS. 7-9 are schematic diagrams of drive principles of the pixel drive circuit of FIG. 1 under the drive timing of FIG. 6.

Reference symbols in the drawings are listed as follows:
1—adjustment sub-circuit, 2—drive sub-circuit, 3—compensation sub-circuit, 4—drive control sub-circuit, 51—first reset sub-circuit, 52—second reset sub-circuit, 61—first light-emitting control sub-circuit, 62—second light-emitting control sub-circuit, 7—storage sub-circuit, 81—first gate, 82—second gate, 91—first insulation layer, 92—second insulation layer, 10—active layer, 11—source, 12—drain, 13—hole, 14—electron, 15—negative ion, 16—first passivation layer, 17—substrate, 18—second passivation layer, 19—photosensitive material layer, 20—pixel electrode layer, N1—first node, N2—second node, N3—third node, N4—fourth node, HV—voltage control signal line, Scan2—second scan signal line, PVDD—power supply voltage line, DATA—data signal line, Scan1—first scan signal line, Vint—initial signal line, Vreset—reset signal line, EMIT—light-emitting control signal line, PVEE—ground terminal, C1—photosensitive capacitor, I₁—current at the first node before compensation, I₂—current at the first node after compensation, T1—first transistor, T2—second transistor, T3—third transistor, T4—fourth transistor, T5—fifth transistor, T6—sixth transistor, T7—dual-gate transistor, and DT—drive transistor.

### DETAILED DESCRIPTION OF THE EMBODIMENTS

In order to make person skilled in the art better understand the schemes of the present application, the following will, in conjunction with the drawings in the embodiments of the present application, clearly and completely describe the technical schemes in the embodiments of the present application. Obviously, the described embodiments are merely some embodiments rather than all the embodiments of the present application. Based on the embodiments in the present application, all the other embodiments obtained by the person skilled in the art without creative labor should be within the protection scope of the present application.

In the specification and the claims as well as aforementioned drawings of the present application, the term “including/comprising” and its variants are intended to cover a non-exclusive inclusion. For example, a process, a method, a system, a product, or an apparatus including a series of steps or units is not limited to the listed steps or units, but may optionally also include steps or units that are not listed, or may optionally include other steps or units inherent to such process, method, product, or apparatus.

In the embodiments of the present application, the same items or similar items with substantially the same functions and effects are distinguished by using “first”, “second”, “fourth”, “fifth”, “sixth” and the like, only for clearly describing the technical schemes of the embodiments of the present application, and cannot be understood as indicating or implying relative importance or implicitly indicating the number of the indicated technical features.

In the embodiments of the present application, the gate of the transistor or the source follower is referred to as a control electrode, one of the source and the drain is referred to as a first electrode, and the other is referred to as a second electrode. In the embodiments of the present application, the source follower and all the transistors are taken as examples for description, in which the first electrode is the source, and the second electrode is the drain.

In the embodiments of the present application, the term “electrically connected” may refer to a direct electrical connection between two components, or may refer to that two components are electrically connected via one or more other components.

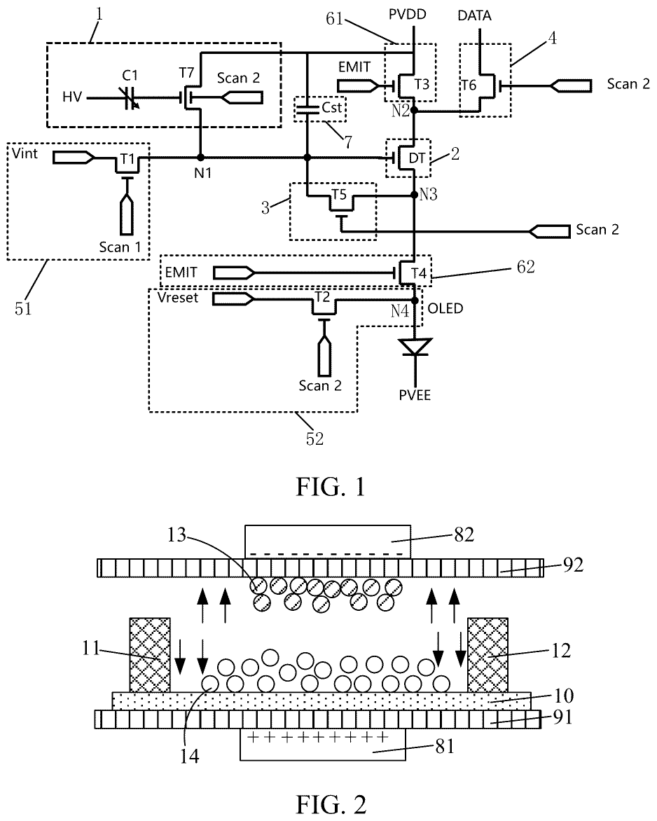

An embodiment of the present application provides a pixel drive circuit, referring to FIG. 1, the pixel drive circuit includes: an adjustment sub-circuit 1, a drive sub-circuit 2, a compensation sub-circuit 3, a drive control sub-circuit 4, a first reset sub-circuit 51, a second reset sub-circuit 52, a first light-emitting control sub-circuit 61, a second light-emitting control sub-circuit 62, and a storage sub-circuit 7.

The adjustment sub-circuit 1 is electrically connected to a voltage control signal line HV, a second scan signal line Scan2, a first node N1 and a power supply voltage line PVDD. The adjustment sub-circuit 1 is configured to, during a data writing phase, compensate for a leakage current at the first node N1 under a joint control of a voltage control signal from the voltage control signal line HV and a scan signal from the second scan signal line Scan2.

The drive sub-circuit 2 is in electrically connected to the first node N1, a second node N2 and a third node N3. The drive sub-circuit 2 is configured to establish a conductive path between the second node N2 and the third node N3 under a control of a voltage at the first node N1, so that a current for driving a light-emitting element to emit light is generated in the conductive path, and the current is continuously generated during a light-emitting phase.

The compensation sub-circuit 3 is electrically connected to the second scan signal line Scan2, the first node N1 and the third node N3. The compensation sub-circuit 3 is configured to, under a control of a scan signal from the second scan signal line Scan2, establish a conductive path between the first node N1 and the third node N3.

The drive control sub-circuit 4 is electrically connected to the second scan signal line Scan2, a data signal line DATA and the second node N2. The drive control sub-circuit 4 is configured to, under the control of the scan signal from the second scan signal line Scan2, write a data signal from the data signal line DATA into the second node N2.

The first reset sub-circuit 51 is electrically connected to a first scan signal line Scan1, an initial signal line Vint and the first node N1, and is configured to, under a control of a scan signal from the first scan signal line Scan1, reset the first node N1 by an initial signal from the initial signal line Vint. The second reset sub-circuit 52 is electrically connected to the second scan signal line Scan2, a reset signal line Vreset and an anode of the light-emitting element, and is configured to, under the control of the scan signal from the second scan signal line Scan2, reset the anode of the light-emitting element by a reset signal from the reset signal line Vreset.

The first light-emitting control sub-circuit 61 is electrically connected to a light-emitting control signal line EMIT, a power supply voltage line PVDD and the second node N2. The second light-emitting control sub-circuit 62 is electrically connected to the light-emitting control signal line EMIT, the third node N3 and the anode of the light-emitting element. The first light-emitting control sub-circuit 61 and the second light-emitting control sub-circuit 62 are respectively configured to, under a control of a light-emitting control signal from the light-emitting control signal line EMIT, transmit a current for driving the light-emitting element to emit light to the anode of the light-emitting element.

The storage sub-circuit 7 is electrically connected to the power supply voltage line PVDD and the first node N1, and is configured to maintain the voltage at the first node N1.

As shown in FIG. 1, the anode of the light-emitting element may be electrically connected to the fourth node N4, and a cathode of the light-emitting element may be electrically connected to a ground terminal PVEE.

Specific circuit structures of the adjustment sub-circuit, the drive sub-circuit, the compensation sub-circuit, the drive control sub-circuit, the first reset sub-circuit, the second reset sub-circuit, the first light-emitting control sub-circuit, the second light-emitting control sub-circuit and the storage sub-circuit are not limited, as long as the corresponding functions are satisfied.

The first node, the second node, the third node and the fourth node are only defined for the convenience of describing the circuit structure, and are not actual circuit units.

If the pixel drive circuit is applied to an OLED display device, the light-emitting element is an OLED. If the pixel drive circuit is applied to a Mini light-emitting Diode (Mini LED) display device, the light-emitting element is a Mini LED. If the pixel drive circuit is applied to a Micro light-emitting Diode (Micro LED) display device, the light-emitting element is a Micro LED. Notably, other types of light-emitting elements may also be possible, and the specific type is subject to actual application.

It should be noted that, in the embodiments of this application, the power supply voltage signal on the power supply voltage line PVDD does not control the light emission of the light-emitting element in the pixel drive circuit. Instead, the power supply voltage line PVDD and the ground terminal PVEE jointly determine a direction of a drive current flowing through the light-emitting element.

The pixel drive circuit provided in the embodiment of the present application can compensate for the leakage current at the first node during the data writing phase by configuring the adjustment sub-circuit as the compensation sub-circuit, so that the potential at the first node changes as little as possible or does not change. This ensures a relatively stable potential at the control electrode of the drive transistor, enabling the drive transistor to continuously generate the drive current during the light-emitting phase, and the brightness of the light-emitting element changes as little as possible or does not change. Consequently, the problems of increased brightness and brightness flickering of the display device employing the pixel drive circuit is effectively reduced, thereby the display device can achieve superior brightness performance, excellent light-emitting effects, and enhanced overall performance.

In one embodiment, the adjustment sub-circuit 1 includes a photosensitive capacitor C1 and a dual-gate transistor T7. A first electrode of the photosensitive capacitor C1 is electrically connected to the voltage control signal line HV. A second electrode of the photosensitive capacitor C1 is electrically connected to a first control electrode of the dual-gate transistor T7. A second control electrode of the dual-gate transistor T7 is electrically connected to the second scan signal line Scan2. A first electrode of the dual-gate transistor T7 is electrically connected to the power supply voltage line PVDD, and a second electrode of the dual-gate transistor T7 is electrically connected to the first node N1.

In practical applications, the photosensitive function may be achieved by adding photosensitive materials to ordinary capacitors, thereby obtaining the photosensitive capacitor C1 in the embodiment of this application. Specifically, the photosensitive capacitor C1 may include a capacitor gate (specifically, a first gate of the dual-gate transistor T7) and a plate arranged on one side of the capacitor gate. A layer of photosensitive material may be arranged between the plate and the capacitor gate. When the ambient light changes, the photosensitive material in the light-sensitive capacitor C1 will increase the quantity of charges within the light-sensitive capacitor C1, causing a change in the current at the first gate of the dual-gate transistor T7. This effectively resolves the impact of ambient light on the current of the drive transistor DT.

In practical applications, the dual-gate transistor T7 may be a dual-gate thin film transistor (TFT), etc.

Referring to FIG. 2, the dual-gate transistor T7 includes a first gate 81, a second gate 82, a first insulation layer 91, a second insulation layer 92, an active layer 10, a source 11 and a drain 12. When different electrical signals are respectively provided to the first gate 81 and the second gate 82 of the dual-gate transistor T7, as shown in FIG. 2, when a positive voltage is provided to the first gate 81 and a negative voltage is provided to the second gate 82, the effect of the electric field on the holes 13 and the electrons 14 is enhanced. More holes 13 will flow towards the second gate 82, and more electrons 14 will flow towards the first gate 81. Moreover, a flow rate of the electrons 14 will increase, and the number of attracted electrons 14 will be greater, and an output on-state current of the dual-gate transistor T7 is larger.

In practical applications, a metal layer may be additionally deposited above the source 11 and the drain 12 in FIG. 2 through methods such as evaporation, etc., to serve as the second gate 82 of the dual-gate transistor T7. The material of the metal layer here may include aluminum (Al), copper (Cu) etc.

It should be noted that the dual-gate transistor T7 may be the same as the drive transistor DT in dimension, type or the like, to facilitate fabrication and control.

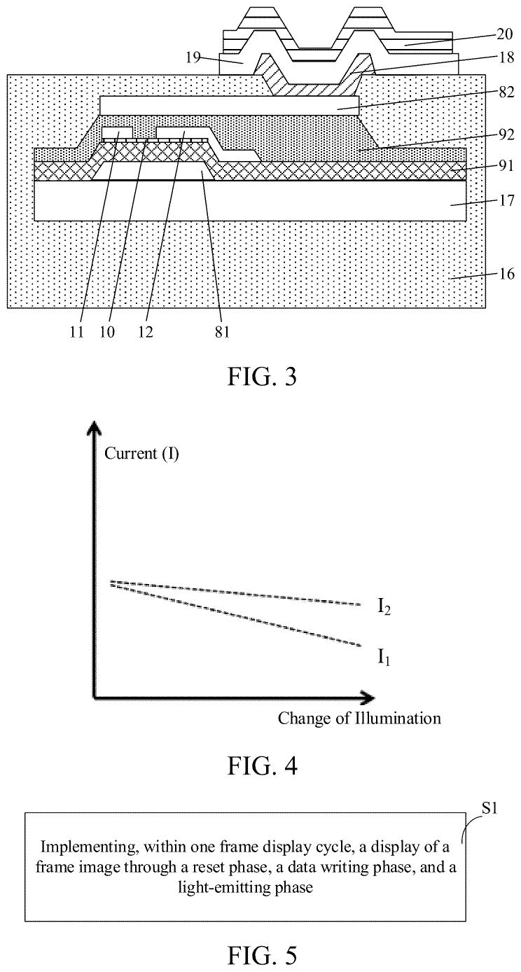

FIG. 3 shows a structural schematic diagram of an adjustment sub-circuit composed of the dual-gate transistor T7 and the drive transistor DT. As shown in FIG. 3, the structure of the adjustment sub-circuit includes a substrate 17, and the first gate 81, the first insulation layer 91, the active layer 10, a source-drain metal layer (including the source 11 and the drain 12), the second insulation layer 92, the second gate 82, a second passivation layer 18, a photosensitive material layer 19 and a pixel electrode layer 20 which are sequentially and lamentedly arranged on the substrate 17. Meanwhile, the structure of the adjustment sub-circuit also includes a first passivation layer 16. The first passivation layer 16 covers all outer surfaces of the substrate 17, the first gate 81, the first insulation layer 91, the active layer 10, the source 11, the drain 12 and the second insulation layer 92. In addition, the first passivation layer 16 also covers part of the outer surface of the second gate 82 and has a groove, and part of the second passivation layer 18 is arranged in the groove.

In applications, the material of the substrate 17 is not limited, which may include a rigid material such as glass etc., or alternatively, a flexible material such as polyimide (PI), etc.

The materials of the first insulation layer 91 and the second insulation layer 92 may both be inorganic materials such as silicon nitride (SiNx), etc.

The material of the active layer 10 may be any one of a non-oxide, an oxide, etc. The non-oxide may include amorphous silicon (a-Si), hydrogenated amorphous silicon (a-Si:H), low temperature poly-silicon (LTPS), etc., which is not specifically limited herein.

The materials of the first gate 81 and the second gate 82 may be metal materials, such as Al, molybdenum (Mo), etc.

The materials of the source 11 and the drain 12 may be metal materials, such as Al, Cu, etc.

The materials of the first passivation layer 16 and the second passivation layer 18 may be silicon dioxide (SiO₂), SiNx, aluminum oxide (Al₂O₃), etc.

It should be noted that other parameters such as the thickness of the aforementioned structures may be obtained according to actual applications, and will not be elaborated here in detail.

Thus, by utilizing the dual-gate structure of the dual-gate transistor T7, the first gate of the dual-gate transistor T7 can form the photosensitive capacitor C1 with the plate and the photosensitive material, and the second gate of the dual-gate transistor T7 can be electrically connected to the second scan signal line Scan2. In this way, when the ambient illumination changes, the photosensitive material can change the number of charges in the photosensitive capacitor C1. Meanwhile, since the second electrode of the photosensitive capacitor C1 is electrically connected to the first control electrode of the dual-gate transistor T7, a change in the current within the dual-gate transistor T7 will be caused. Moreover, since the second control electrode of the dual-gate transistor T7 is electrically connected to the second scan signal line Scan2, during the data writing phase, the second control electrode of the dual-gate transistor T7 is switched on. At this time, the voltage polarities at the first control electrode and the second control electrode of the dual-gate transistor T7 are opposite, forming electric fields with opposing directions relative to the first electrode and second electrode of dual-gate transistor T7, thereby exerting opposing effects on holes 13 and electrons 14. Under the influence of the two electric fields, the electron flow rate in the dual-gate transistor T7 is faster, attracting a greater number of electrons, resulting in a larger on-state current output from the dual-gate transistor T7. At this point, the current stored at the first node N1 is I₂, making I₂>I₁, it thus is possible to compensate for the leakage current at the first node N1 caused by factors such as illumination or prolonged charging.

It should be noted that FIG. 4 shows a schematic diagram showing variations of I₁ and I₂, where I₁ is the current at the first node N1 before compensation, and I₂ is the current at the first node N1 after compensation. As shown in FIG. 4, with the change of illumination, the current I₁ of the first node N1 before compensation decreases faster, while the current I₂ of the first node N1 after compensation decreases slower, and I₂>I₁.

In an embodiment, the drive sub-circuit 2 includes a drive transistor DT, a control electrode of the drive transistor DT is electrically connected to the first node N1, a first electrode of the drive transistor DT is electrically connected to the second node N2, and a second electrode of the drive transistor DT is electrically connected to the third node N3.

During the data writing phase, the combined action of the dual-gate transistor T7 and the photosensitive capacitor C1 can compensate for the leakage current at the first node N1 caused by illumination or prolonged charging. This ensures the threshold voltage of the drive transistor DT, and enables the drive transistor DT to continuously generate current during the light-emitting phase to maintain the brightness of the light-emitting element as normal as possible.

In an embodiment, the compensation sub-circuit 3 includes a fifth transistor T5. A control electrode of the fifth transistor T5 is electrically connected to the second scan signal line Scan2, a first electrode of the fifth transistor T5 is electrically connected to the third node N3, and a second electrode of the fifth transistor T5 is electrically connected to the first node N1.

In an embodiment, the drive control sub-circuit 4 includes a sixth transistor T6. A control electrode of the sixth transistor T6 is electrically connected to the second scan signal line Scan2, a first electrode of the sixth transistor T6 is electrically connected to the data signal line DATA, and a second electrode of the sixth transistor T6 is electrically connected to the second node N2.

In an embodiment, the first reset sub-circuit 51 includes a first transistor T1. A control electrode of the first transistor T1 is electrically connected to the first scan signal line Scan1, a first electrode of the first transistor T1 is electrically connected to the initial signal line Vint, and a second electrode of the first transistor T1 is electrically connected to the first node N1. The second reset sub-circuit 52 includes a second transistor T2. A control electrode of the second transistor T2 is electrically connected to the second scan signal line Scan2, a first electrode of the second transistor T2 is electrically connected to the reset signal line Vreset, and a second electrode of the second transistor T2 is electrically connected to the anode of the light-emitting element.

In an embodiment, the first light-emitting control sub-circuit 61 includes a third transistor T3. A control electrode of the third transistor T3 is electrically connected to the light-emitting control signal line EMIT, a first electrode of the third transistor T3 is electrically connected to the power supply voltage line PVDD, and a second electrode of the third transistor T3 is electrically connected to the second node N2. The second light-emitting control sub-circuit 62 includes a fourth transistor T4. A control electrode of the fourth transistor T4 is electrically connected to the light-emitting control signal line EMIT, a first electrode of the fourth transistor T4 is electrically connected to the third node N3, and a second electrode of the fourth transistor T4 is electrically connected to the anode of the light-emitting element.

It should be noted that the second electrode of the third transistor T3, the first electrode of the drive transistor DT, and the second electrode of the sixth transistor T6 are all electrically connected to the second node N2. That is, the second electrode of the third transistor T3, the first electrode of the drive transistor DT, and the second electrode of the sixth transistor T6 are electrically connected.

The first electrode of the fourth transistor T4, the second electrode of the drive transistor DT, and the first electrode of the fifth transistor T5 are all electrically connected to the third node N3. That is, the first electrode of the fourth transistor T4, the second electrode of the drive transistor DT, and the first electrode of the fifth transistor T5 are electrically connected.

The second electrode of the fourth transistor T4 and the second electrode of the second transistor T2 are both electrically connected to the anode of the light-emitting element. That is, the second electrode of the fourth transistor T4 and the second electrode of the second transistor T2 are electrically connected.

In an embodiment, the storage sub-circuit 7 includes a storage capacitor Cst. A first electrode of the storage capacitor Cst is electrically connected to the power supply voltage line PVDD, and a second electrode of the storage capacitor Cst is electrically connected to the first node N1.

It should be noted that the first electrode of the storage capacitor Cst, the first electrode of the dual-gate transistor T7, and the first electrode of the third transistor T3 are all electrically connected to the power supply voltage line PVDD. That is, the first electrode of the storage capacitor Cst, the first electrode of the dual-gate transistor T7, and the first electrode of the third transistor T3 are electrically connected.

The second electrode of the storage capacitor Cst, the second electrode of the first transistor T1, the second electrode of the fifth transistor T5, the second electrode of the dual-gate transistor T7, and the control electrode of the drive transistor DT are all electrically connected to the first node N1. That is, the second electrode of the storage capacitor Cst, the second electrode of the first transistor T1, the second electrode of the fifth transistor T5, the second electrode of the dual-gate transistor T7, and the control electrode of the drive transistor DT are electrically connected.

In actual application, the first transistor T1, the second transistor T2, the third transistor T3, the fourth transistor T4, the fifth transistor T5, the sixth transistor T6, the dual-gate transistor T7, and the drive transistor DT may all be thin film transistors (TFTs), and may specifically be any one of a non-oxide TFT, an oxide TFT, etc. Among them, the non-oxide TFT may include an a-Si TFT, an LTPS TFT, etc., and no specific limitations are imposed here.

To ensure unified manufacturing processes and facilitate a simpler drive method for subsequent circuits, the first transistor T1, the second transistor T2, the third transistor T3, the fourth transistor T4, the fifth transistor T5, the sixth transistor T6, the dual-gate transistor T7, and the drive transistor DT may all be N-type transistors. Or alternatively, the first transistor T1, the second transistor T2, the third transistor T3, the fourth transistor T4, the fifth transistor T5, the sixth transistor T6, the dual-gate transistor T7, and the drive transistor DT may all be P-type transistors. No specific limitations are imposed here.

In the pixel drive circuit provided by the embodiments of the present application, a compensation sub-circuit is formed by configuring a photosensitive capacitor and a dual-gate transistor. Thus, when ambient light changes, the charge quantity within the photosensitive capacitor varies, causing a change in the current of the dual-gate transistor. During the data writing phase, electric fields of opposite directions are formed between the first and second electrodes of the dual-gate transistor, exerting opposing effects on holes and electrons. Under the influence of these two electric fields, the electron flow rate in the dual-gate transistor becomes faster, attracting more electrons and resulting in a larger on-state current. This compensates for the leakage current at the first node caused by factors such as illumination or prolonged charging, ensuring the drive transistor to continuously generate the drive current during the light-emitting phase and maintains the brightness of the light-emitting element as much as possible. Consequently, display devices employing this pixel drive circuit exhibit superior brightness, excellent light-emitting effect, and enhanced performance.

An embodiment of the present application provides a display device, including a plurality of pixel units arranged in an array and the pixel drive circuit as shown in the above embodiments. The pixel drive circuit is electrically connected to the plurality of pixel units and is configured to control the plurality of pixel units.

The display device may be a flexible display device (also referred to as a flexible screen) or a rigid display device (i.e., a display screen that cannot be bent), which will not be limited herein.

The display device may be an OLED display device, a Micro LED display device, or a Mini LED display device, and may be a television, a digital camera, a mobile phone, a tablet computer, or any product or component having a display function. The display device may also be applied to the fields of identity recognition and medical instruments, and products that have been promoted or have a good promotion prospect including security identity authentication, intelligent door locks, medical image acquisition, and the like.

The display device has advantages such as excellent luminous brightness, superior display performance, low cost, long lifespan, high stability, high contrast ratio, outstanding imaging quality, premium product quality, etc.

An embodiment of the present application provides a control method for the pixel drive circuit as shown the above embodiments.

As shown in FIG. 5, the control method includes step S1.

In step S1, within one frame display cycle, a display of a frame image is implemented through a reset phase, a data writing phase, and a light-emitting phase.

An operating sequence of the pixel drive circuit in the embodiments of the present application may be referred to as shown in FIG. 5, with the following detailed explanation:

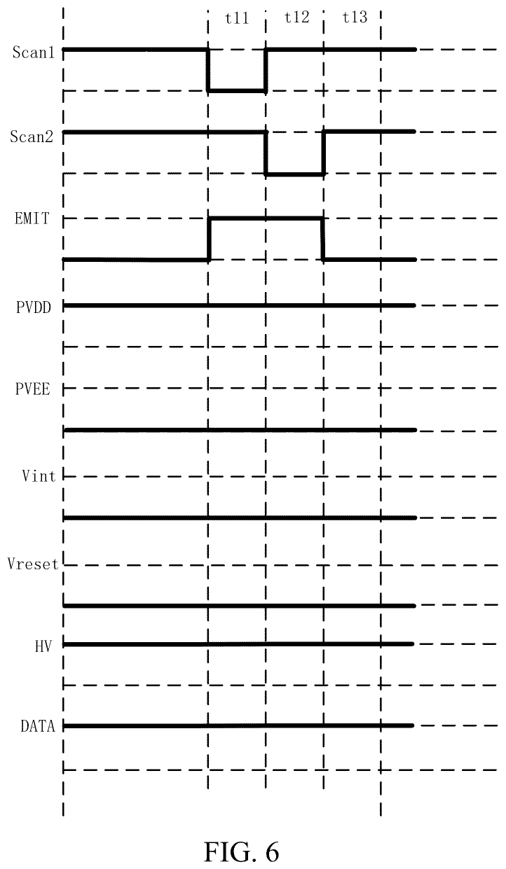

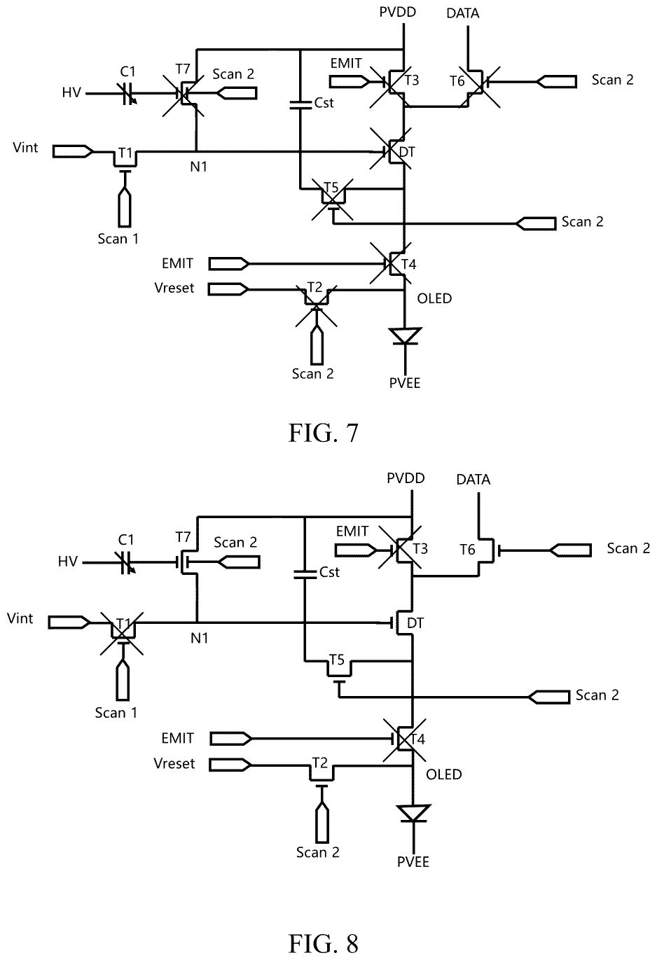

An operating principle of the pixel drive circuit as shown in FIG. 1 provided by the embodiment of the present application is specifically introduced below by taking that the first transistor T1, the second transistor T2, the third transistor T3, the fourth transistor T4, the fifth transistor T5, the sixth transistor T6, the dual-gate transistor T7, and the drive transistor DT are N-type low-temperature polysilicon TFTs, and the light-emitting element is OLED as an example, in combination with the timing diagram of each signal line as shown in FIG. 6. It should be noted that in FIG. 7 to FIG. 9, the transistor being switched off is indicated by an “×” mark, and the light-emitting element does not emit light is also indicated by an “×” mark.

### Initialization Phase

At a t11 phase in FIG. 6, low-level signals are input to the first scan signal line Scan1, the initial signal line Vint, the reset signal line Vreset, and the ground terminal PVEE, and high-level signals are input to the second scan signal line Scan2, the light-emitting control signal line EMIT, the power supply voltage line PVDD, the voltage control signal line HV, and the data signal line DATA. At this time, referring to FIG. 7, the first transistor T1 is switched on, and the second transistor T2, the third transistor T3, the fourth transistor T4, the fifth transistor T5, the sixth transistor T6, the dual-gate transistor T7, and the drive transistor DT are all switched off.

Since the first transistor T1 is switched on, the initial signal from the initial signal line Vint can be written to the first node N1, and the first node N1 is initialized to the initial signal from the initial signal line Vint.

### Data Writing Phase

At a t12 phase in FIG. 6, low-level signals are input to the second scan signal line Scan2, the initial signal line Vint, the reset signal line Vreset, and the ground terminal PVEE, and high-level signals are input to the first scan signal line Scan1, the light-emitting control signal line EMIT, the power supply voltage line PVDD, the voltage control signal line HV, and the data signal line DATA. At this time, referring to FIG. 8, the second transistor T2, the fifth transistor T5, the sixth transistor T6, the dual-gate transistor T7, and the drive transistor DT are all switched on, and the first transistor T1, the third transistor T3, and the fourth transistor T4 are all switched off.

Since the fifth transistor T5 and the sixth transistor T6 are switched on, the data signal from the data signal line DATA is written to the gate of the drive transistor DT and a self-compensation is completed. Meanwhile, since the second transistor T2 is switched on, the reset signal from the reset signal line Vreset is transmitted to the anode of the OLED, so that the OLED is reset. In addition, the data signal from the data signal line DATA is also written to the second electrode of the storage capacitor Cst and charges the storage capacitor Cst.

More importantly, the second scanning signal line Scan2 inputs a low-level signal, at which point the dual-gate transistor T7 is switched on. When the ambient light intensity changes, the photosensitive material causes the charge quantity in the photosensitive capacitor C1 to vary. Simultaneously, since the second electrode of the photosensitive capacitor C1 is electrically connected to the first control gate of the dual-gate transistor T7, this drives a change in the current through the dual-gate transistor T7. Furthermore, since the second control gate of dual-gate transistor T7 is connected to the second scan signal line Scan2, during the data writing phase, the second control gate of dual-gate transistor T7 is switched on. At this point, the voltage polarities at the first and second control gates of dual-gate transistor T7 are opposite, forming electric fields with opposing directions relative to the first and second electrodes of dual-gate transistor T7 respectively. Consequently, these electric fields exert opposing effects on holes 13 and electrons 14. Under the influence of these two electric fields, the electron flow rate in dual-gate transistor T7 increases significantly, attracting more electrons and resulting in a higher on-state current output from dual-gate transistor T7. At this time, the current stored in the first node N1 is I₂, satisfying I₂>I₁, thereby the leakage current at the first node N1 caused by factors such as illumination or prolonged charging can be compensated.

### Light-Emitting Phase

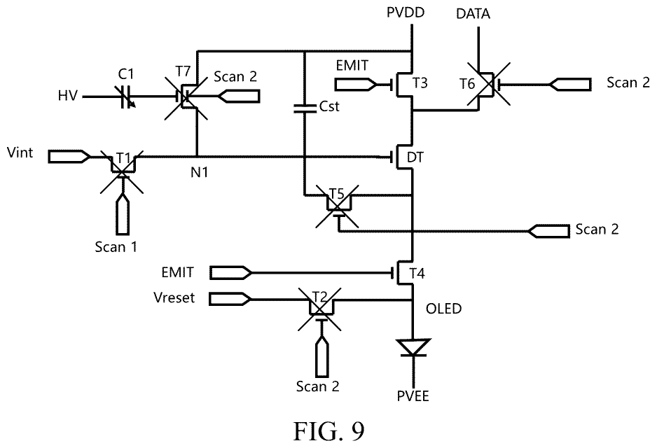

In the t13 phase in FIG. 6, low-level signals are input to the light-emitting control signal line EMIT, the initial signal line Vint, the reset signal line Vreset and the ground terminal PVEE, and high-level signals are input to the first scan signal line Scan1, the second scan signal line Scan2, the power supply voltage line PVDD, the voltage control signal line HV and the data signal line DATA. At this time, referring to FIG. 9, the third transistor T3, the fourth transistor T4 and the drive transistor DT are all switched on, and the first transistor T1, the second transistor T2, the fifth transistor T5, the sixth transistor T6 and the dual-gate transistor T7 are all switched off.

Since the third transistor T3 and the fourth transistor T4 are switched on, the power supply voltage signal from the power supply voltage line PVDD is transmitted to the first electrode of the drive transistor DT, enabling the drive transistor DT to generate a drive current, and since the leakage current at the first node is compensated, the drive current can continuously generated to flow to the anode of the OLED, to drive the OLED to emit light, thus the light-emitting brightness is relatively stable.

In the above process, the drive current Ids generated by the drive transistor DT is expressed as follows:

Ids=(1/2)×μ×(W/L)×CGI×(VDD−Vdata−Vth)², where, CGI is a capacitance of the gate oxide of the drive transistor DT (i.e. a gate capacitance), VDD is the power supply voltage of the power supply voltage line PVDD, Vdata is the data signal from the data signal line DATA (i.e. the data voltage), Vth is the threshold voltage of the drive transistor DT, W is a channel width of the drive transistor DT, L is a channel length of the drive transistor DT, and μ is a carrier mobility of the drive transistor DT.

In the control method for the pixel drive circuit provided in the embodiments of the present application, when the ambient light varies, the change in the quantity of charges within the photosensitive capacitor during the data writing phase induces a change in the current of the dual-gate transistor. During the data writing phase, opposing electric fields are formed between the first and second electrodes of the dual-gate transistor, exerting contrary effects on holes and electrons. Under the influence of dual electric fields, the electron flow rate in dual-gate transistors is faster, attracting a greater number of electrons and resulting in a higher on-state current. This compensates for the leakage current at the first node caused by factors such as illumination or prolonged charging, thereby enabling the drive transistor to continuously generate the drive current during the light-emitting phase and minimizing changes in the brightness of the light-emitting element. Additionally, this approach allows the pixel drive circuit to drive the light-emitting element effectively, with a simple and easily achievable timing sequence.

Here, only the content related to the present application points is introduced, and other structures may be obtained by referring to the related arts, which will not be elaborated here in detail.

The above are merely some preferred embodiments of the present application and are not intended to limit the present application. Any modifications, equivalent replacements, and improvements made within the spirit and principles of this application shall all be included within the protection scope of the present application.

What is claimed is:

1. A pixel drive circuit, comprising:
an adjustment sub-circuit, electrically connected to a voltage control signal line, a second scan signal line, a first node and a power supply voltage line, and configured to compensate for a leakage current at the first node under a joint control of a voltage control signal from the voltage control signal line and a scan signal from the second scan signal line during a data writing phase;
a drive sub-circuit, electrically connected to the first node, a second node and a third node, and configured to establish a conductive path between the second node and the third node under a control of a voltage at the first node, so that a current for driving a light-emitting element to emit light is generated in the conductive path, and the current is continuously generated during a light-emitting phase;
a compensation sub-circuit, electrically connected to the second scan signal line, the first node and the third node, and configured to establish a conductive path between the first node and the third node under a control of a scan signal from the second scan signal line;
a drive control sub-circuit, electrically connected to the second scan signal line, a data signal line and the second node, and configured to write a data signal from the data signal line into the second node under the control of the scan signal from the second scan signal line;
a first reset sub-circuit and a second reset sub-circuit, wherein the first reset sub-circuit is electrically connected to a first scan signal line, an initial signal line and the first node, and is configured to reset the first node by an initial signal from the initial signal line under a control of a scan signal from the first scan signal line, and wherein the second reset sub-circuit is electrically connected to the second scan signal line, a reset signal line and an anode of the light-emitting element, and is configured to reset the anode of the light-emitting element by a reset signal from the reset signal line under the control of the scan signal from the second scan signal line;
a first light-emitting control sub-circuit and a second light-emitting control sub-circuit, wherein the first light-emitting control sub-circuit is electrically connected to a light-emitting control signal line, the power supply voltage line and the second node, the second light-emitting control sub-circuit is electrically connected to the light-emitting control signal line, the third node and the anode of the light-emitting element, the first light-emitting control sub-circuit and the second light-emitting control sub-circuit are respectively configured to transmit the current for driving the light-emitting element to emit light to the anode of the light-emitting element under a control of a light-emitting control signal from the light-emitting control signal line; and
a storage sub-circuit, electrically connected to the power supply voltage line and the first node, and configured to maintain the voltage at the first node.

2. The pixel drive circuit according to claim 1, wherein the adjustment sub-circuit comprises a photosensitive capacitor and a dual-gate transistor;
a first electrode of the photosensitive capacitor is electrically connected to the voltage control signal line, and a second electrode of the photosensitive capacitor is electrically connected to a first control electrode of the dual-gate transistor; and
a second control electrode of the dual-gate transistor is electrically connected to the second scan signal line, a first electrode of the dual-gate transistor is electrically connected to the power supply voltage line, and a second electrode of the dual-gate transistor is electrically connected to the first node.

3. The pixel drive circuit according to claim 1, wherein the drive sub-circuit comprises a drive transistor; and
a control electrode of the drive transistor is electrically connected to the first node, a first electrode of the drive transistor is electrically connected to the second node, and a second electrode of the drive transistor is electrically connected to the third node.

4. The pixel drive circuit according to claim 1, wherein the compensation sub-circuit comprises a fifth transistor; and
a control electrode of the fifth transistor is electrically connected to the second scan signal line, a first electrode of the fifth transistor is electrically connected to the third node, and a second electrode of the fifth transistor is electrically connected to the first node.

5. The pixel drive circuit according to claim 1, wherein the drive control sub-circuit comprises a sixth transistor; and
a control electrode of the sixth transistor is electrically connected to the second scan signal line, a first electrode of the sixth transistor is electrically connected to the data signal line, and a second electrode of the sixth transistor is electrically connected to the second node.

6. The pixel drive circuit according to claim 1, wherein the first reset sub-circuit comprises a first transistor, a control electrode of the first transistor is electrically connected to the first scan signal line, a first electrode of the first transistor is electrically connected to the initial signal line, and a second electrode of the first transistor is electrically connected to the first node; and
the second reset sub-circuit comprises a second transistor, a control electrode of the second transistor is electrically connected to the second scan signal line, a first electrode of the second transistor is electrically connected to the reset signal line, and a second electrode of the second transistor is electrically connected to the anode of the light-emitting element.

7. The pixel drive circuit according to claim 1, wherein the first light-emitting control sub-circuit comprises a third transistor, a control electrode of the third transistor is electrically connected to the light-emitting control signal line, a first electrode of the third transistor is electrically connected to the power supply voltage line, and a second electrode of the third transistor is electrically connected to the second node; and
the second light-emitting control sub-circuit comprises a fourth transistor, a control electrode of the fourth transistor is electrically connected to the light-emitting control signal line, a first electrode of the fourth transistor is electrically connected to the third node, and a second electrode of the fourth transistor is electrically connected to the anode of the light-emitting element.

8. The pixel drive circuit according to claim 1, wherein the storage sub-circuit comprises a storage capacitor; and
a first electrode of the storage capacitor is electrically connected to the power supply voltage line, and a second electrode of the storage capacitor is electrically connected to the first node.

9. A display device, comprising:
a plurality of pixel units arranged in an array; and
a pixel drive circuit, comprising:
an adjustment sub-circuit, electrically connected to a voltage control signal line, a second scan signal line, a first node and a power supply voltage line, and configured to compensate for a leakage current at the first node under a joint control of a voltage control signal from the voltage control signal line and a scan signal from the second scan signal line during a data writing phase;
a drive sub-circuit, electrically connected to the first node, a second node and a third node, and configured to establish a conductive path between the second node and the third node under a control of a voltage at the first node, so that a current for driving a light-emitting element to emit light is generated in the conductive path, and the current is continuously generated during a light-emitting phase;
a compensation sub-circuit, electrically connected to the second scan signal line, the first node and the third node, and configured to establish a conductive path between the first node and the third node under a control of a scan signal from the second scan signal line;
a drive control sub-circuit, electrically connected to the second scan signal line, a data signal line and the second node, and configured to write a data signal from the data signal line into the second node under the control of the scan signal from the second scan signal line;
a first reset sub-circuit and a second reset sub-circuit, wherein the first reset sub-circuit is electrically connected to a first scan signal line, an initial signal line and the first node, and is configured to reset the first node by an initial signal from the initial signal line under a control of a scan signal from the first scan signal line, and wherein the second reset sub-circuit is electrically connected to the second scan signal line, a reset signal line and an anode of the light-emitting element, and is configured to reset the anode of the light-emitting element by a reset signal from the reset signal line under the control of the scan signal from the second scan signal line;
a first light-emitting control sub-circuit and a second light-emitting control sub-circuit, wherein the first light-emitting control sub-circuit is electrically connected to a light-emitting control signal line, the power supply voltage line and the second node, the second light-emitting control sub-circuit is electrically connected to the light-emitting control signal line, the third node and the anode of the light-emitting element, the first light-emitting control sub-circuit and the second light-emitting control sub-circuit are respectively configured to transmit the current for driving the light-emitting element to emit light to the anode of the light-emitting element under a control of a light-emitting control signal from the light-emitting control signal line; and
a storage sub-circuit, electrically connected to the power supply voltage line and the first node, and configured to maintain the voltage at the first node,
wherein the pixel drive circuit is electrically connected to the plurality of pixel units and is configured to control the plurality of pixel units.

10. The display device according to claim 9, wherein the adjustment sub-circuit comprises a photosensitive capacitor and a dual-gate transistor;
a first electrode of the photosensitive capacitor is electrically connected to the voltage control signal line, and a second electrode of the photosensitive capacitor is electrically connected to a first control electrode of the dual-gate transistor; and
a second control electrode of the dual-gate transistor is electrically connected to the second scan signal line, a first electrode of the dual-gate transistor is electrically connected to the power supply voltage line, and a second electrode of the dual-gate transistor is electrically connected to the first node.

11. The display device according to claim 9, wherein the drive sub-circuit comprises a drive transistor; and
a control electrode of the drive transistor is electrically connected to the first node, a first electrode of the drive transistor is electrically connected to the second node, and a second electrode of the drive transistor is electrically connected to the third node.

12. The display device according to claim 9, wherein the compensation sub-circuit comprises a fifth transistor; and
a control electrode of the fifth transistor is electrically connected to the second scan signal line, a first electrode of the fifth transistor is electrically connected to the third node, and a second electrode of the fifth transistor is electrically connected to the first node.

13. The display device according to claim 9, wherein the drive control sub-circuit comprises a sixth transistor; and
a control electrode of the sixth transistor is electrically connected to the second scan signal line, a first electrode of the sixth transistor is electrically connected to the data signal line, and a second electrode of the sixth transistor is electrically connected to the second node.

14. The display device according to claim 9, wherein the first reset sub-circuit comprises a first transistor, a control electrode of the first transistor is electrically connected to the first scan signal line, a first electrode of the first transistor is electrically connected to the initial signal line, and a second electrode of the first transistor is electrically connected to the first node; and
the second reset sub-circuit comprises a second transistor, a control electrode of the second transistor is electrically connected to the second scan signal line, a first electrode of the second transistor is electrically connected to the reset signal line, and a second electrode of the second transistor is electrically connected to the anode of the light-emitting element.

15. The display device according to claim 9, wherein the first light-emitting control sub-circuit comprises a third transistor, a control electrode of the third transistor is electrically connected to the light-emitting control signal line, a first electrode of the third transistor is electrically connected to the power supply voltage line, and a second electrode of the third transistor is electrically connected to the second node; and
the second light-emitting control sub-circuit comprises a fourth transistor, a control electrode of the fourth transistor is electrically connected to the light-emitting control signal line, a first electrode of the fourth transistor is electrically connected to the third node, and a second electrode of the fourth transistor is electrically connected to the anode of the light-emitting element.

16. The display device according to claim 9, wherein the storage sub-circuit comprises a storage capacitor; and
a first electrode of the storage capacitor is electrically connected to the power supply voltage line, and a second electrode of the storage capacitor is electrically connected to the first node.

17. A control method for controlling the pixel drive circuit according to claim 1, the control method comprising:
implementing, within one frame display cycle, a display of a frame image through a reset phase, the data writing phase and the light-emitting phase.
